(19) United States
(12) Patent Application Publication
(10) Pub. No.: US 2026/0340711 A1
(43) Pub. Date: Oct. 29, 2026

(54) NON-TRANSITORY COMPUTER-READABLE STORAGE MEDIA, INFORMATION PROCESSING APPARATUS, AND INFORMATION PROCESSING METHOD

(71) Applicant: Nintendo Co., Ltd., Kyoto (JP)

(72) Inventors: Haruna SUGANO, Kyoto (JP); Toshikazu JIN, Kyoto (JP); Shotaro GOTO, Kyoto (JP); Hayuru SOMA, Kyoto (JP)

(21) Appl. No.: 19/551,012

(22) Filed: Feb. 26, 2026

(30) Foreign Application Priority Data
Mar. 5, 2025 (JP) 2025-034442

(51) Int. Cl. G06Q 30/0601

(52) U.S. Cl. CPC G06Q 30/0641

(57) ABSTRACT

One or more non-transitory computer-readable storage media have stored therein instructions that, when executed, cause one or more processors to perform operations comprising: displaying an item trade screen D that includes a cursor CR and a plurality of Items A; moving the cursor CR in accordance with an operation input from a D-pad; decreasing the item acquisition quantity of one of Items A designated by the cursor CR in a case where the item acquisition quantity can be decreased, and ending the item purchase event without causing the user to acquire any of Items A in a case where the item acquisition quantity cannot be decreased, in accordance with an operation input from a B button; and causing the user to acquire Items A each having a quantity determined according to the corresponding item acquisition quantity in accordance with an acquisition instruction based on an operation input.

### CROSS REFERENCE TO RELATED APPLICATION

This nonprovisional application is based on Japanese Patent Application No. 2025- 34442 filed with the Japan Patent Office on Mar. 5, 2025, the entire contents of which are hereby incorporated by reference.

### FIELD

The present disclosure relates to game processing that provides an item trade method with improved usability.

### BACKGROUND AND SUMMARY

It is known that an item designated by an indicator image is caused to be purchased on an item purchase screen presenting a plurality of items (JP 2023-27583 A).

In the prior art, there was room for improvement in item purchase methods.

### Configuration 1

One or more non-transitory computer-readable storage media have stored therein instructions that, when executed, cause one or more processors to perform operations comprising:
performing an item trade event in accordance with an event start instruction based on an operation input,
where the item trade event comprises:
displaying an item trade screen that includes a cursor and a plurality of items;
moving the cursor in accordance with a first operation input;
increasing an item acquisition quantity of one of the items designated by the cursor in accordance with a second operation input, the item acquisition quantity indicating a quantity of item to be acquired by a user;
decreasing the item acquisition quantity of one of the items designated by the cursor in a case where the item acquisition quantity can be decreased, and ending the item trade event without causing the user to acquire any of the items in a case where the item acquisition quantity cannot be decreased, in accordance with a third operation input; and
causing the user to acquire the items each having a quantity determined according to the corresponding item acquisition quantity in accordance with an acquisition instruction based on an operation input.

This configuration allows for executing a process of decreasing the item acquisition quantity and another process of ending the item trade event in accordance with the third operation input. Moreover, the two processes can be switched according to whether the item acquisition quantity of the item designated by the cursor can be decreased or not.

### Configuration 2

In the one or more non-transitory computer-readable storage media according to Configuration 1, the item trade event may further comprise:
displaying a warning message for warning of an end of the item trade event without ending the item trade event in a case where the item acquisition quantity of one of the items designated by the cursor cannot be decreased in accordance with the third operation input; and
ending the item trade event without causing the user to acquire any of the items in a case where an end instruction based on an operation input different from the third operation input is issued while the warning message is displayed.

This configuration requires entry of an operation input different from the third operation input in order to end the item trade event on the screen where the warning message is displayed in accordance with the third operation input, and therefore can prevent the item trade event from ending unintentionally due to consecutive third operation inputs.

### Configuration 3

In the one or more non-transitory computer-readable storage media according to Configuration 2, the item trade event may further comprise:
hiding the warning message without ending the item trade event in a case where the third operation input is entered while the warning message is displayed.

When the third operation input is entered on the screen where the warning message is displayed, this configuration allows the process to be returned to the item trade event with the third operation input being assumed to be entered consecutively without an intention to end the item trade event.

### Configuration 4

In the one or more non-transitory computer-readable storage media according to Configuration 2, the item trade event may further comprise:
displaying the warning message without ending the item trade event in a case where the item acquisition quantity of a first one of the items designated by the cursor cannot be decreased and that the item acquisition quantity of a second one of the items can be decreased in accordance with the third operation input; and
ending the item trade event without displaying the warning message and without causing the user to acquire any of the items in a case where any of the item acquisition quantities of the items cannot be decreased in accordance with the third operation input.

In this way, if the third operation input is entered when any of the items cannot be decreased, for example, while the state remains unchanged from the state at the start of the item trade, the item trade event can be ended without displaying the warning message with the end of the item trade event being assumed to be intentional.

### Configuration 5

In the one or more non-transitory computer-readable storage media according to any of Configurations 1 to 4, the item trade event may further comprise:
determining whether a continuous input condition is satisfied or not, the continuous input condition being satisfied when a continuous operation input is generated over a first period; and
decreasing the item acquisition quantity of one of the items designated by the cursor in a case where the item acquisition quantity can be decreased, and keeping the item trade event running in a case where the item acquisition quantity cannot be decreased, while the third operation input satisfies the continuous input condition.

Such specification where the item acquisition quantity of the item designated by the cursor is decreased while the continuous input condition is satisfied causes the state where the item acquisition quantity cannot be decreased any more if the continuous input condition continues. Keeping the item trade event running in such a case prevents the item trade event from ending unintentionally.

### Configuration 6

In the one or more non-transitory computer-readable storage media according to any of Configurations 1 to 5, the item trade event may further comprise:
decreasing a quantity of a designated item owned by the user and causing the item to be used, in accordance with an item use instruction based on an operation input.

Item trade events occur frequently in such a case where the quantity of owned item decreases as the item is used. Improving the usability of the item trade event can make repeated operations more comfortable.

### (Configuration 7

In the one or more non-transitory computer-readable storage media according to any of Configurations 1 to 5, the item trade event may further comprise:
switching between a first item trade screen including at least a first item and a second item trade screen including at least a second item in accordance with a screen switch instruction based on an operation input; and
causing the user to acquire the first and second items each having a quantity determined according to the corresponding item acquisition quantity in accordance with the acquisition instruction.

This configuration allows the first and second items to be obtained together in accordance with the acquisition instruction even when there are the first and second item trade screens. Additionally, the item trade event can be ended by the third operation input without switching from one screen to the other in order to decrease the item acquisition quantity.

### Configuration 8

In the one or more non-transitory computer-readable storage media according to Configuration 7, the item trade event may further comprise:
displaying a warning message without ending the item trade event in a case where the item acquisition quantity of a first one of the items designated by the cursor cannot be decreased and that the item acquisition quantity of a second one of the items included in the first or second item trade screen can be decreased in accordance with the third operation input; and
ending the item trade event without displaying the warning message and without causing the user to acquire any of the items in a case where any of the item acquisition quantities of the items included in the first or second item trade screen cannot be decreased in accordance with the third operation input.

When there are the first and second item trade screens, this configuration allows the warning message to be displayed without the need to switch from one screen to the other if there is an item whose item acquisition quantity can be decreased, and can prevent the item trade event from ending unintentionally.

### Configuration 9

In the one or more non-transitory computer-readable storage media according to any of Configurations 1 to 8, the item trade event may further comprise:
ending the item trade event without causing the user to acquire any of the items in a case where the third operation input is entered without any of the items being designated by the cursor.

In this way, if the third operation input is entered without any item being designated by the cursor, the item trade event can be ended with the end of the item trade event being assumed to be intentional.

### Configuration 10

An information processing apparatus comprises one or more processors, memory, an input unit, and an output unit, and the one or more processors are caused to perform operations comprising:
performing an item trade event in accordance with an event start instruction based on an operation input,
where the item trade event comprises:
displaying an item trade screen that includes a cursor and a plurality of items;
moving the cursor in accordance with a first operation input;
increasing an item acquisition quantity of one of the items designated by the cursor in accordance with a second operation input, the item acquisition quantity indicating a quantity of item to be acquired by a user;
decreasing the item acquisition quantity of one of the items designated by the cursor in a case where the item acquisition quantity can be decreased, and ending the item trade event without causing the user to acquire any of the items in a case where the item acquisition quantity cannot be decreased, in accordance with a third operation input; and
causing the user to acquire the items each having a quantity determined according to the corresponding item acquisition quantity in accordance with an acquisition instruction based on an operation input.

### Configuration 11

An information processing method performed by a computer comprises:
performing an item trade event in accordance with an event start instruction based on an operation input,
where the item trade event comprises:
displaying an item trade screen that includes a cursor and a plurality of items;
moving the cursor in accordance with a first operation input;
increasing an item acquisition quantity of one of the items designated by the cursor in accordance with a second operation input, the item acquisition quantity indicating a quantity of item to be acquired by a user;
decreasing the item acquisition quantity of one of the items designated by the cursor in a case where the item acquisition quantity can be decreased, and ending the item trade event without causing the user to acquire any of the items in a case where the item acquisition quantity cannot be decreased, in accordance with a third operation input; and
causing the user to acquire the items each having a quantity determined according to the corresponding item acquisition quantity in accordance with an acquisition instruction based on an operation input.

### Configuration 12

An information processing system comprises one or more processors, memory, an input unit, and an output unit, and the one or more processors are caused to perform operations comprising:
performing an item trade event in accordance with an event start instruction based on an operation input,
where the item trade event comprises:
displaying an item trade screen that includes a cursor and a plurality of items;
moving the cursor in accordance with a first operation input;
increasing an item acquisition quantity of one of the items designated by the cursor in accordance with a second operation input, the item acquisition quantity indicating a quantity of item to be acquired by a user;
decreasing the item acquisition quantity of one of the items designated by the cursor in a case where the item acquisition quantity can be decreased, and ending the item trade event without causing the user to acquire any of the items in a case where the item acquisition quantity cannot be decreased, in accordance with a third operation input; and
causing the user to acquire the items each having a quantity determined according to the corresponding item acquisition quantity in accordance with an acquisition instruction based on an operation input.

The foregoing and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is a block diagram showing an example of a hardware configuration of an information processing apparatus of an embodiment;

FIG. 2 shows an appearance of a game apparatus of the embodiment;

FIG. 3 shows an example of an item purchase screen;

FIG. 4 shows an example of the item purchase screen;

FIG. 5 shows an example of the item purchase screen where a warning message is displayed;

FIG. 6 shows a process of an item purchase event;

FIG. 7 shows a process for when a direction input is entered;

FIG. 8 shows a process for when an A-button input is entered;

FIG. 9 shows a process for when a B-button input is entered;

FIG. 10 shows a process for when a plus-button input is entered;

FIG. 11 shows a process for when another input is entered;

FIG. 12 shows a process for when a warning flag is on;

FIG. 13 shows another example of the item purchase screen;

FIG. 14 shows another example of the item purchase screen; and

FIG. 15 shows another example of the item purchase screen.

### DETAILED DESCRIPTION OF NON-LIMITING EXAMPLE EMBODIMENTS

Now, an information processing apparatus and an information processing program of an embodiment will be described with reference to the drawings. It should be noted that the following description is merely illustrative of preferred modes and is not intended to limit the invention described in the claims.

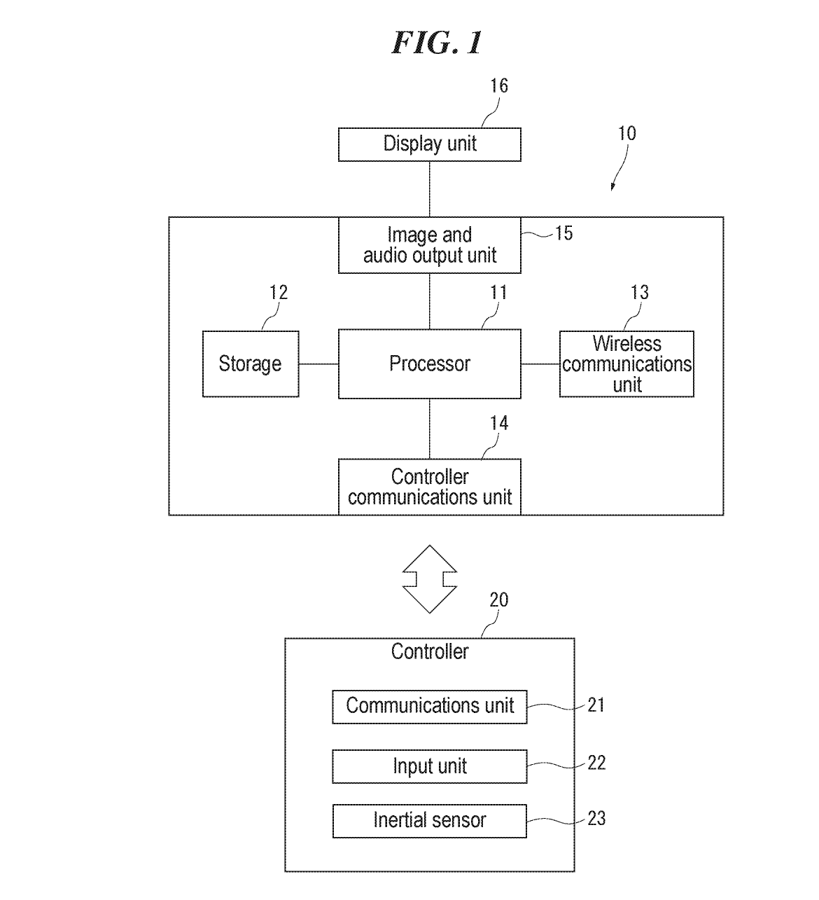

FIG. 1 is a block diagram showing an example of a hardware configuration of an information processing apparatus 10 of the embodiment. The information processing apparatus 10 is, for example, a smartphone, a stationary or portable game apparatus, a tablet terminal, a mobile phone, a personal computer, a wearable terminal, or the like. Information processing of the embodiment can also be applied to an information processing system comprising a game apparatus or the like described above and a specified server apparatus. A game apparatus will be described as an example in the embodiment. The information processing apparatus 10 is hereinafter referred to as the "game apparatus 10."

In FIG. 1, the game apparatus 10 has a processor 11. The processor 11 is an information processing unit that executes various information processes executed in the game apparatus 10, and may comprise, for example, only a CPU (Central Processing Unit), or an SoC (System-on-a-Chip) that includes a plurality of functions such as a CPU function and a GPU (Graphics Processing Unit) function. The processor 11 executes an information processing program (e.g., a game program) stored in a storage 12 to execute the various information processes. It should be noted that the storage 12 may be, for example, an internal storage medium such as flash memory and DRAM (Dynamic Random Access Memory), or configured to use an external storage medium or the like mounted in a not shown slot.

The game apparatus 10 has a wireless communications unit 13 for the game apparatus 10 to wirelessly communicate with another game apparatus and a specified server apparatus. Internet communications and short-range wireless communications, for example, are used as the wireless communications. The game apparatus 10 also has a controller communications unit 14 for performing wired or wireless communications with a controller 20.

The game apparatus 10 is connected with a display unit 16 (e.g., a television) via an image and audio output unit 15. The processor 11 outputs images and audio generated (by, e.g., executing the above-described information processes) to the display unit 16 via the image and audio output unit 15.

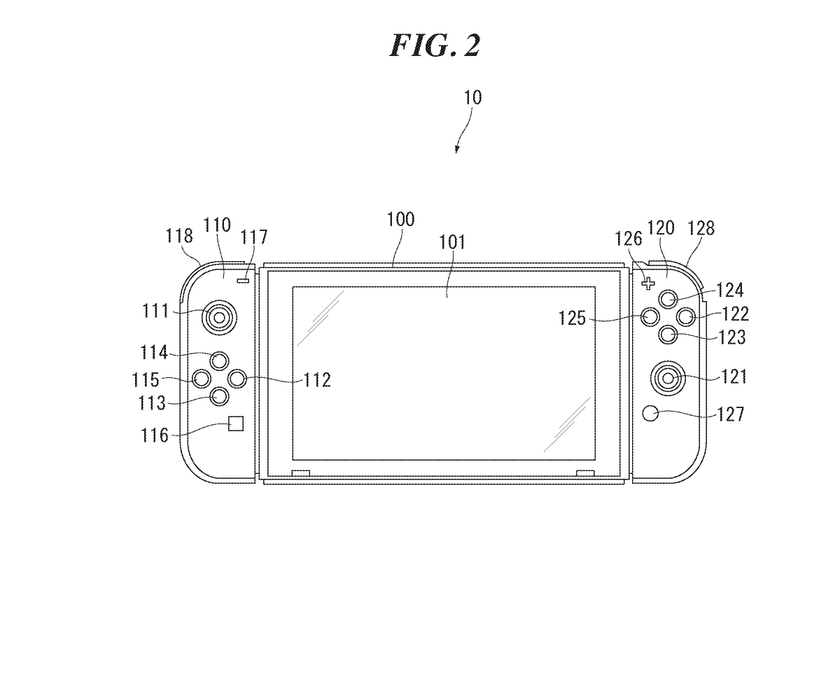

The controller 20 comprises a communications unit 21, an input unit 22, and an inertial sensor 23. The input unit 22 comprises various buttons, analog sticks, and the like, which will be described in detail with reference to FIG. 2.

FIG. 2 shows an appearance of the game apparatus 10 of the embodiment. The game apparatus 10 of the embodiment comprises a game apparatus body 100 equipped with a touch-panel display 101, a left controller 110, and a right controller 120. The left controller 110 and the right controller 120 correspond to the controller 20 shown in FIG. 1.

The left controller 110 comprises an analog stick 111 and four operation buttons (specifically, a right button 112, a down button 113, an up button 114, and a left button 115). The left controller 110 further comprises a capture button 116, a - (minus) button 117, and an L button 118. The right controller 120, like the left controller 110, comprises an analog stick 121 and four operation buttons (specifically, an A button 122, a B button 123, an X button 124, and a Y button 125) as a direction input unit. The right controller 120 further comprises a + (plus) button 126, a home button 127, and an R button 128.

The left controller 110 and the right controller 120 can be attached to and removed from the game apparatus body 100. That is, the game apparatus 10 can be used as an integrated apparatus in which the left controller 110 and the right controller 120 are mounted to the game apparatus body 100. The game apparatus 10 can also be used with the game apparatus body 100, the left controller 110, and the right controller 120 as separate units.

Returning to FIG. 1, the description will be continued. The inertial sensor 23 includes, for example, an accelerometer and an angular velocity sensor. In the embodiment, the accelerometer detects magnitudes of acceleration along specified three-axis directions. The angular velocity sensor detects angular velocities about specified three axes.

The communications unit 21 has a function to perform wired or wireless communications with the controller communications unit 14 described above. Information on an operation input entered into the input unit 22 and various detection results obtained by the inertial sensor 23 are output to the communications unit 21 repeatedly in a timely manner, and are sent to the game apparatus 10.

Processes of an item trade event performed by the game apparatus 10 will now be described. First, transition of screens displayed by the game apparatus 10 will be described.

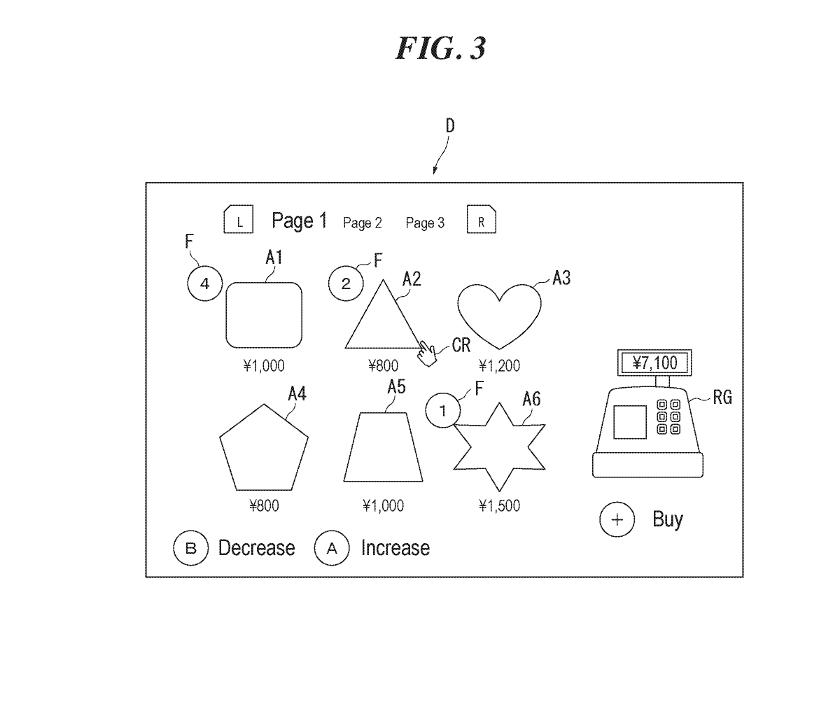

FIG. 3 shows a purchase screen for items (hereinafter referred to as the "item purchase screen") D at a store as an example of the item trade event. In the embodiment, an item purchase event for purchasing items from the store will be described as the item trade event. Triggers for opening the item purchase screen may be, for example: a user's character entering a shop placed in a virtual space; an operation input for entering a shop placed in a virtual space being entered by designating the shop with a cursor; a user's character talking with an NPC (Non-Player Character) who trades items; and selecting shopping from a menu, but how to start the item trade event is not limited to these.

The item purchase screen D includes a plurality of items available for purchase A1 to A6, and a cursor CR that moves within the item purchase screen D and designates the items A1 to A6 to be purchased. When a direction input operation is performed with the analog stick 121, the cursor CR moves in the input direction. The items A1 to A6 are hereinafter collectively referred to as "Item A." The amounts of money displayed below each of the items A1 to A6 are their respective prices. They are indicated in "yen" for convenience of description, but the unit may be any unit appropriate to the game since what is used for purchasing Item A is an in-game currency. While the embodiment is described with the example in which Item A is purchased with an in-game currency, the processing method of the item trade event of the embodiment can be applied to a case in which items available for free are acquired.

Circled numbers F displayed at the upper-left of the items A1, A2, and A6 are the item acquisition quantities of the respective items. The item acquisition quantities are the quantities of the relevant items A1, A2, and A6 that are attempted to be purchased. Instead of displaying the numbers F at the upper-left of Item A, a cart for accepting items to be purchased may be provided, into which items corresponding to the item acquisition quantities are put.

In the example shown in FIG. 3, an attempt is made to purchase four units of the upper-left rectangular item A1, two units of the upper-center triangular item A2, and one unit of the lower-right star-shaped item A6. It should be noted that no upper-left circled number is displayed for items whose item acquisition quantity is zero. There is a register RG on the right side of the items A1 to A6, and the sum total of the currently selected items A1, A2, and A6 is displayed on a display of the register RG.

While Items A are schematically shown in FIG. 3, examples of Items A to be traded in the item purchase event include: presents for characters (food, clothes, equipment, power-up items, etc.); objects installed in a virtual space, such as furniture, ornaments, and buildings; and items to be used by the user (e.g., stamina-restoring items in stamina-system games). Items to be traded in the item purchase event are not limited to the examples described above.

A circled "+" sign and a text "Buy" are displayed below the register RG, which indicates that Item A can be purchased with the plus button. If the user presses the plus button on the screen shown in FIG. 3, the user acquires four units of the rectangular item A1, two units of the triangular item A2, and one unit of the star-shaped item A6 in exchange for 7100 yen of in-game currency, and owns these items A1, A2, and A6. As described later, the store has a plurality of pages, and the screen can be switched to select items on other pages. If the acquisition quantity is set for Item A on another page that is not displayed in FIG. 3, pressing the plus button allows the Item A on the other page to be purchased, too, at the same time.

The purchase of items may be caused to be performed by a method other than the plus button. For example, the purchase of Item A can be confirmed by an operation of providing an item purchase button on the item purchase screen D, pointing the cursor CR to the item purchase button, and pressing the A button.

While the above description gives the example in which the user owns the acquired items, the items purchased on the item purchase screen D may be used immediately. For example, items that temporarily enhance a player character's attack power or defense power may be purchased and simultaneously used for the player character, and the item purchase screen D may handle such items.

A circled "B" sign and a text "Decrease" are displayed at the lower left of the item purchase screen D, which indicates that the acquisition quantity of the item A designated by the cursor CR can be decreased by pressing the B button. In this example, pressing the B button allows for decreasing the item acquisition quantity of the triangular item A2. In the cart example, the B button corresponds to removing an item designated by the cursor from the cart. Long-pressing the B button allows for decreasing purchase quantity quicker than repeated short presses.

The B button is described here. A game to which the processing method of the item trade event of the embodiment is applied has various events in addition to the item trade event, and those events progress in response to operation inputs from the user. Those events include, for example, an event in which the user selects and uses the user's own item, an event in which items are installed to edit a virtual space, and an event in which a character is caused to be equipped with weapons and protectors. The B button is often used when various events in games are ended, and is intuitively associated with event-ending operations from the perspective of users who play games.

A circled "A" sign and a text "Increase" are displayed on the right side of the B-button display at the bottom of the item purchase screen D, which indicates that the acquisition quantity of Item A designated by the cursor CR can be increased by pressing the A button. In this example, pressing the A button allows for increasing the item acquisition quantity of the triangular item A2. In the cart example, the B button corresponds to adding the item A2 designated by the cursor to the cart. Long-pressing the A button allows for increasing purchase quantity quicker than repeated short presses.

There is a display "Page 1 Page 2 Page 3" at the top of the item purchase screen D, where the display "Page 1" is more emphasized than the displays "Page 2" and "Page 3." This indicates that this store has three pages, i.e., page 1, page 2, and page 3, and the user is currently on page 1. While in the example shown in FIG. 3 the current page is emphasized by increasing its font size to be larger than that of the other pages, how to emphasize is not limited to changing the font size, and there may be another method, such as changing the color, adding a frame border, and underlining.

"L" on the left side and "R" on the right side of "Page 1 Page 2 Page 3" indicate that pressing the L button allows for transition to the page on the left side of the emphasized page and pressing the R button allows for transition to the page on the right side, and after the page transition a list of Items A provided for the page is displayed. The page transition may be performed by the cursor CR. That is, the page may be switched to the page designated by the cursor CR when the cursor CR is pointed to one of the pages "Page 1 Page 2 Page 3" and a confirm button is pressed.

With such a provision of a plurality of pages, there may be a configuration in which, for example, weapon items are sold at page 1, healing items are sold at page 2, and ornaments and accessories are sold at page 3. Placing different Items A for each page in this way allows a player to select a page appropriate to the purpose and to purchase necessary Item A efficiently.

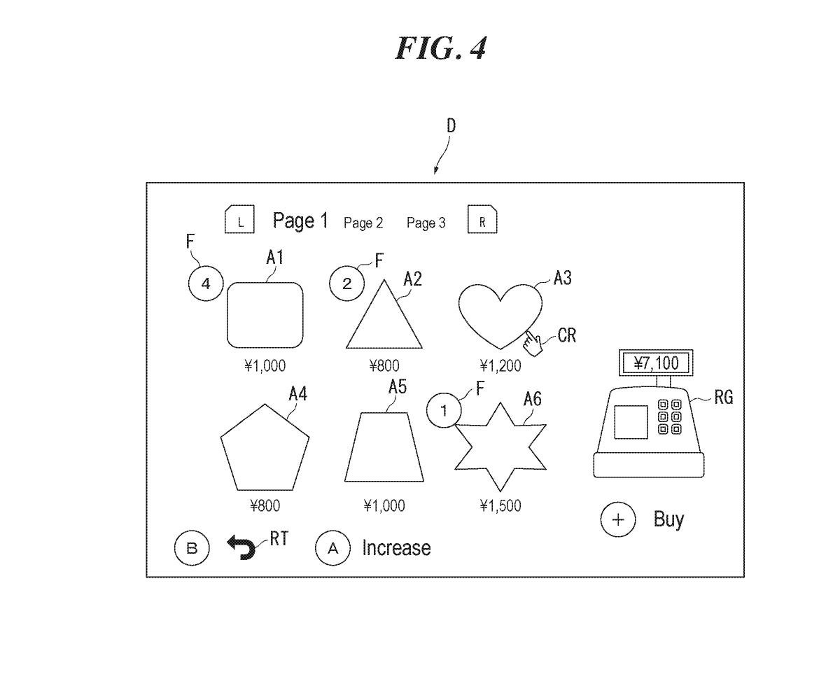

FIG. 4 is another example of the item purchase screen D. The cursor CR is designating a heart-shaped item A3 in FIG. 4. The item purchase screen D shown in FIG. 4 is at a state where the cursor CR is moved to right by an operation input to the analog stick 121 entered on the item purchase screen D shown in FIG. 3. The item acquisition quantity of the heart-shaped item A3 is zero, and therefore cannot be decreased. In the cart example, this corresponds to a state where there is no cursor-designated item in the cart.

A circled "B" sign and a back arrow RT are displayed at the lower left of the item purchase screen D, which indicates that the user can leave the store by pressing the B button. In this way, the role of the B button is different from that on the item purchase screen D shown in FIG. 3. In the example shown in FIG. 4, since the item acquisition quantity of the heart-shaped item A3 is zero and cannot be decreased any more, the role of the B button has changed from decreasing the item acquisition quantity to leaving the store.

The change in the role of the B button will be described using conceivable operations as an example. For example, the acquisition quantity of the triangular item decreases from two to one to zero each time the B button is pressed on the item purchase screen D shown in FIG. 3, the display at the lower left of the item purchase screen D changes from "Decrease" to the back arrow RT when the acquisition quantity of the triangular item becomes zero, and if the B button is pressed again in that state, the user's character leaves the store and the item trade event is ended.

In the embodiment, however, if there is any item whose item acquisition quantity is not zero among Items A other than the item designated by the cursor CR, a warning message M that asks whether it is OK to leave the store or not is displayed instead of the item purchase event being ended without notice. The other items described above may include items on other pages. For example, the warning message M is displayed even if the item acquisition quantity of all Items A on page 1 is zero and if there is any item whose item acquisition quantity is not zero on page 2 or 3.

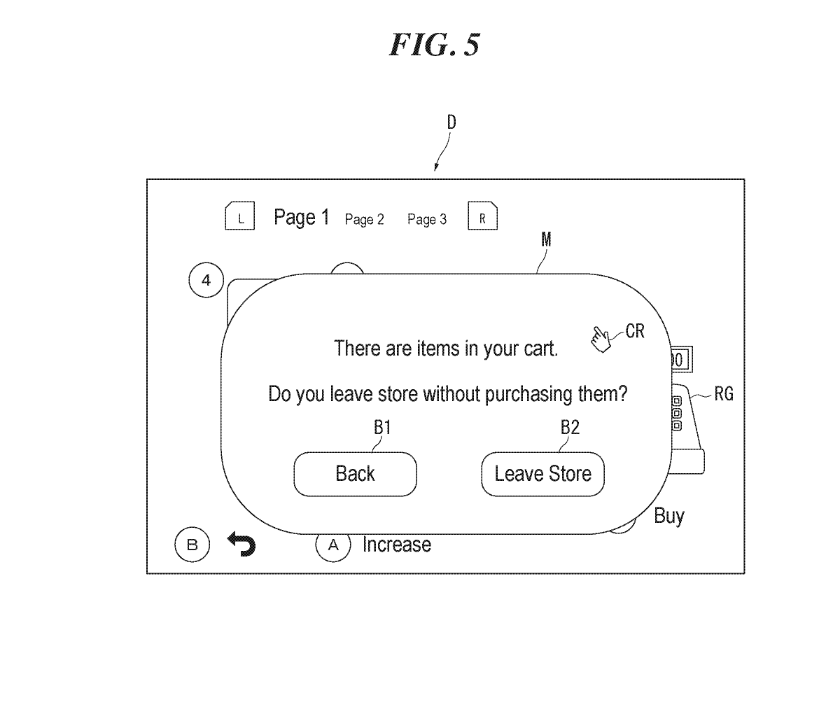

FIG. 5 shows a screen where the warning message M is displayed. As shown in FIG. 5, the warning message M "There are items in your cart. Do you leave the store without purchasing them?" is caused to pop up, and either of a "Back" button B1 or a "Leave Store" button B2 can be selected by the cursor CR. If the "Back" button B1 is selected, the process returns to the store and the item trade event continues. If the "Leave Store" button B2 is selected, the user's character leaves the store and the item trade event ends.

It should be noted that the selection of either "Back" or "Leave Store" can be performed by pressing a button. In the embodiment, the B button is assigned to "Back," and one or more buttons other than the B button are assigned to "Leave Store." Some users may press the B button repeatedly when they decrease the item acquisition quantity, and then the item acquisition quantity becomes zero, causing the warning message M to be displayed. Buttons other than the B button are assigned to "Leave Store" to prevent the user's character from leaving the store unintentionally due to the user pressing the B button excessively, due to the momentum of repeated presses, on the screen displaying the warning message M.

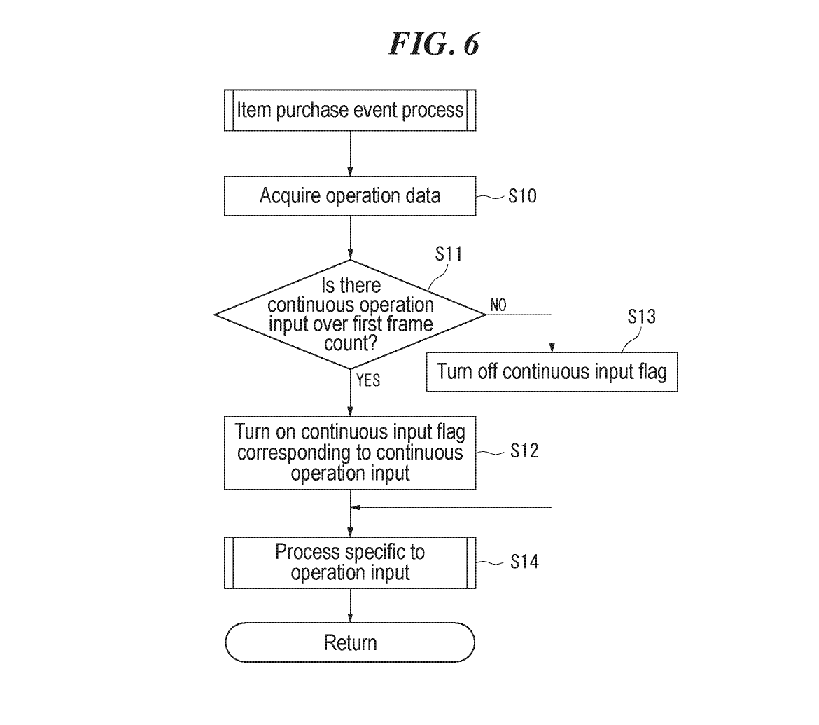

Referring to FIGS. 6 to 12, information processes of the game apparatus 10 related to the item trade event will be described. The item trade event described below is realized by the processor 11 executing the information processing program of the embodiment.

The item trade event is an event in a game executed by the information processing program. The item trade event is started by, for example, a user's character entering a shop placed in a virtual space, or the like. When the item trade event starts, the item purchase screen is displayed on the display 101 of the game apparatus 10.

FIG. 6 shows a process of the item purchase event. Acquiring operation data input from the input unit 22 (S10), the game apparatus 10 determines whether there is a continuous operation input over a first frame count or not (S11). This determination on whether there is a continuous operation input over the first frame count or not is to determine whether the input is a long press or a short press according to the duration of the operation input. The first frame count of the embodiment is, for example, two, and an operation input is determined to be a long press if the operation input is the same as that of the immediately preceding frame.

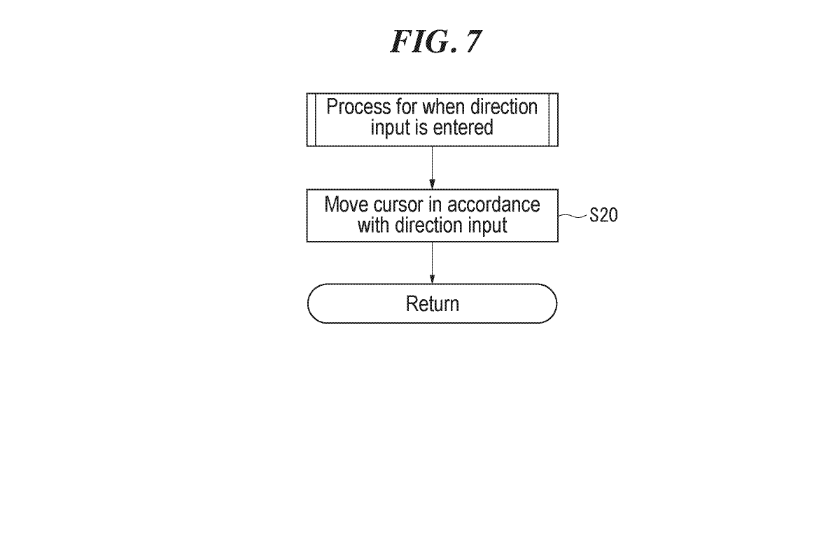

If it is determined that there is a continuous operation input over the first frame count (YES at S11), a continuous input flag corresponding to the continuous operation input is turned on (S12). If it is determined that there is not a continuous operation input over the first frame count (NO at S11), the continuous input flag is turned off (S13). The game apparatus 10 then performs a process specific to the acquired operation input (S14). Processes for each operation input will be described with reference to FIGS. 7 to 11.

FIG. 7 shows a process for when a direction input is entered. When accepting a direction input, the game apparatus 10 moves the cursor in accordance with the direction input (S20). The direction input is entered, for example, from the analog stick 121 of the right controller 120. In accordance with the direction input, the cursor jumps from item to item to perform so-called snap movement. Although the embodiment describes the example in which the cursor moves with snap-to behavior, the cursor may be caused to move continuously on the screen in accordance with the direction input. In this case, the cursor can move to any point in a space between items on the item purchase screen. While the embodiment is described with the game apparatus 10 as an example, the direction input may be entered by, for example, a mouse or other devices when the disclosure is applied to other information processing apparatuses.

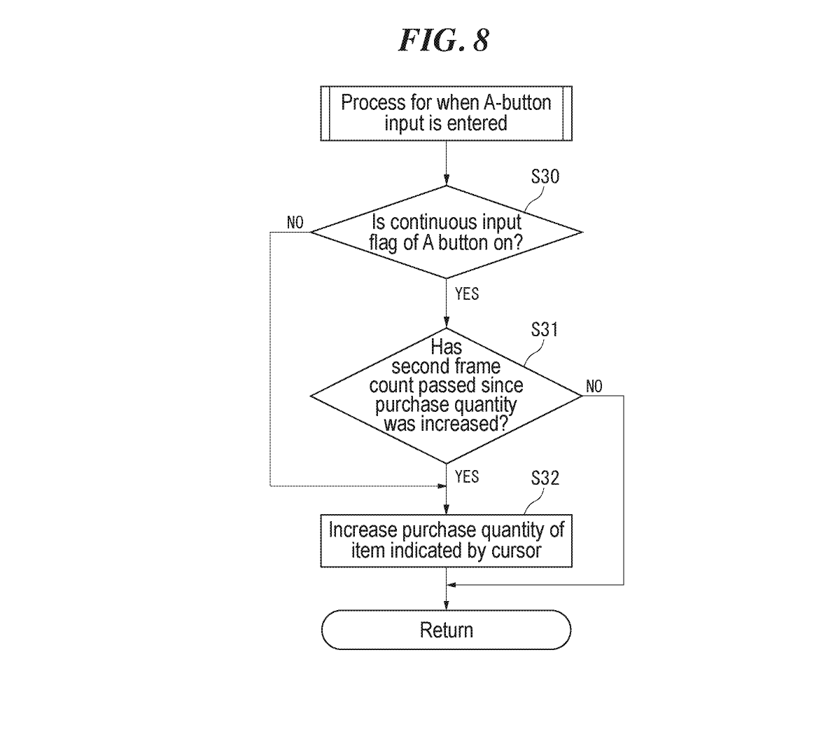

FIG. 8 shows a process for when an A-button input is entered. As shown in FIG. 3 and the like, the A button increases the item acquisition quantity on the item purchase screen. When accepting an A-button input, the game apparatus 10 determines whether a continuous input flag of the A button is on or not (S30). If the continuous input flag is not on (NO at S30), that is, if the A button is short-pressed, the game apparatus 10 increases the purchase quantity of an item indicated by the cursor (S32). When the cursor is not designating any item, the process of increasing item purchase quantity is not performed even if the A button is pressed.

If the continuous input flag is on (YES at S30), that is, if the A button is long-pressed, whether a second frame count has passed since the purchase quantity was increased or not is determined (S31). If the second frame count has passed since the purchase quantity was increased (YES at S31), the game apparatus 10 increases the purchase quantity of the item indicated by the cursor (S32). If the second frame count has not passed since the purchase quantity was increased (NO at S31), the game apparatus 10 returns the process without increasing the item purchase quantity.

The reason why whether the second frame count has passed since the purchase quantity was increased or not is determined as described above is because the item purchase quantity increases too fast if the item purchase quantity is increased each time the input is determined to be a long press. The item increase rate can be appropriately adjusted by increasing the item purchase quantity after the second frame count has passed since the purchase quantity was increased previous time. For example, if the second frame count is set to 10 when the game apparatus 10 operates at a rendering frame rate of 60 fps, the item purchase quantity can be caused to increase at a rate of 6 per second.

It should be noted that the second frame count does not have to be constant and may be reduced gradually as the duration of the long press increases. This allows the item increase rate to be raised as the duration of the long press increases. For example, if the second frame count is set to be reduced gradually from 10 to 8 to 6, the rate of increase in the item purchase quantity increases gradually from 6 to 7.5 to 10 per second.

Pressing the A button allows the item acquisition quantity to increase, but items exceeding the funds cannot be purchased. When the sum total based on the acquisition quantity of selected items (i.e., the sum total displayed on the display of the register RG) exceeds the user's funds, the game apparatus of the embodiment may provide a display to notify the user of the excess state. For example, when the item acquisition quantity being increased one more causes the sum total to exceed the funds, the item may be grayed out so that the item acquisition quantity cannot be increased.

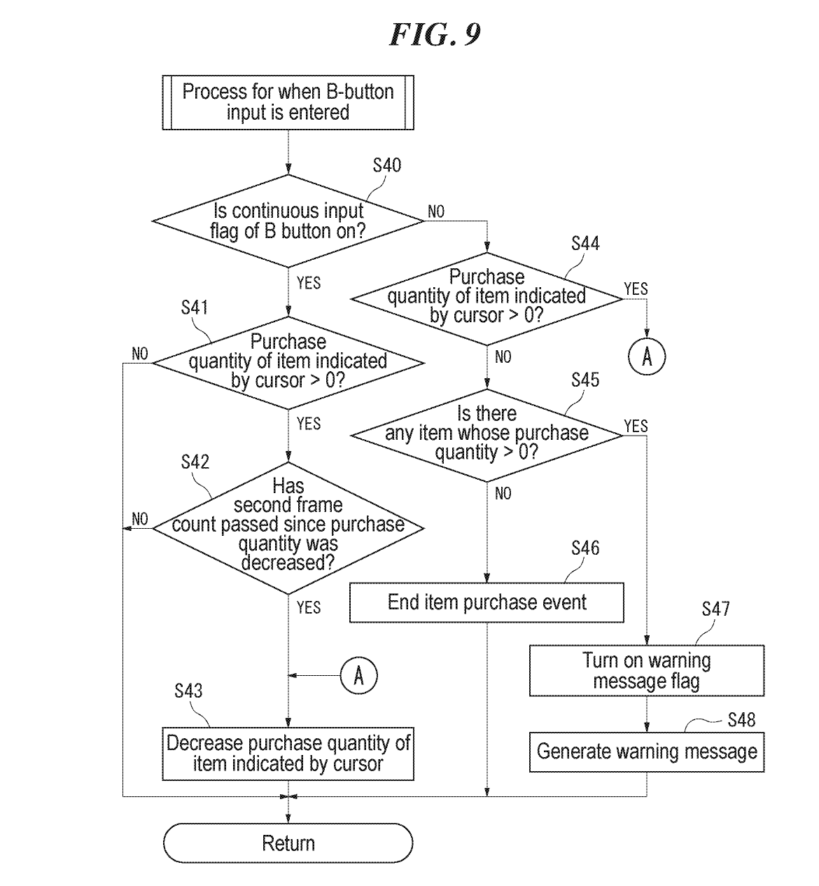

FIG. 9 shows a process for when a B-button input is entered. As shown in FIG. 3 and the like, the B button decreases the item acquisition quantity or causes the user's character to leave the store on the item purchase screen. When accepting a B-button input, the game apparatus 10 determines whether a continuous input flag of the B button is on or not (S40). If the continuous input flag is not on (NO at S40), that is, if the B button is short-pressed, the game apparatus 10 determines whether the purchase quantity of an item indicated by the cursor is greater than zero or not (S44). If the purchase quantity of the item indicated by the cursor is greater than zero (YES at S44), the game apparatus 10 decreases the purchase quantity of the item indicated by the cursor (S43).

If the purchase quantity of the item indicated by the cursor is not greater than zero (NO at S44), that is, if the purchase quantity of the item indicated by the cursor is zero, the game apparatus 10 determines whether there is any item among items other than the item indicated by the cursor whose purchase quantity is greater than zero or not (S45). If there is no item whose purchase quantity is greater than zero among the rest of the items (NO at S45), the user's character is caused to leave the store, and the item purchase event is ended (S46).

If there is any item whose purchase quantity is greater than zero among the rest of the items (YES at S45), the game apparatus 10 turns on a warning message flag (S47), then generates such a warning message as shown in FIG. 5, and displays it in a pop-up manner on the item purchase screen (S48).

The operation when the continuous input flag of the B button is on (YES at S40) will now be described. If the continuous input flag of the B button is on, that is, if a long press of the B button is detected, the game apparatus 10 determines whether the purchase quantity of the item indicated by the cursor is greater than zero or not (S41). If the purchase quantity of the item is greater than zero, the game apparatus 10 determines whether the second frame count has passed since the purchase quantity was decreased or not (S42). If the determination result indicates that the second frame count has passed since the purchase quantity was decreased (YES at S42), the game apparatus 10 decreases the purchase quantity of the item indicated by the cursor (S43). The reason why whether the second frame count has passed or not is determined is the same as the case of the A button described with FIG. 8.

It should be noted that also in the case of the B button, as with the case of the A button, the second frame count does not have to be constant and may be reduced gradually as the duration of the long press increases. This allows the item decrease rate to be raised as the duration of the long press increases. Moreover, while the process has the steps of comparing the long press duration with the second frame count for both the A and B buttons (S31 and S42), the second frame count may be the same or different for the A and B buttons.

If the purchase quantity of the item indicated by the cursor is determined not to be greater than zero in the determination at S41 (NO at S41), that is, if the purchase quantity of the item indicated by the cursor is zero, the game apparatus 10 returns the process. In other words, the process of ending the item trade event is not performed when the B-button input is a long press.

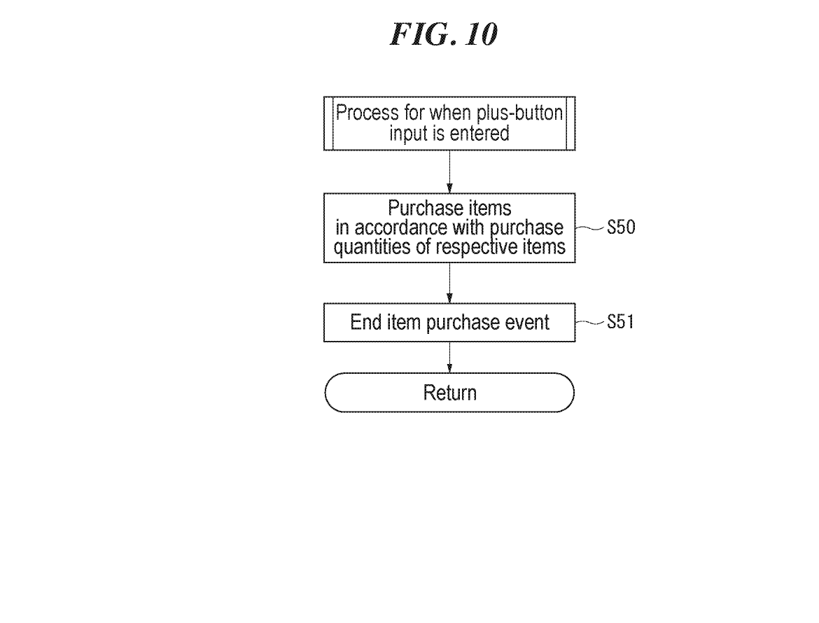

FIG. 10 shows a process for when a plus-button input is entered. When accepting a plus-button input, the game apparatus 10 performs a process of purchasing items in accordance with the purchase quantities of the respective items (S50). Specifically, the game apparatus 10 causes items corresponding to their respective purchase quantities to be owned by the user, and subtracts the total price of the items from the user’s own in-game currency. The game apparatus 10 then ends the item purchase event (S51).

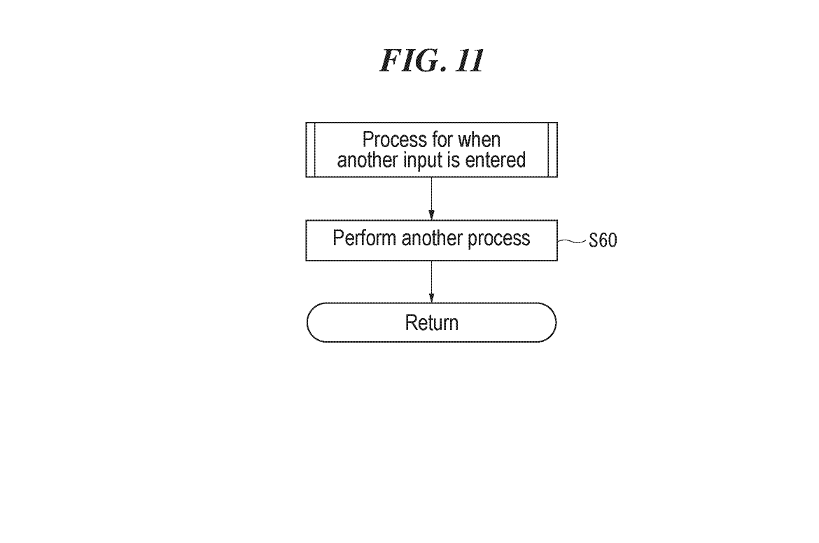

FIG. 11 is a process for when another input is entered. When another input is entered, another process corresponding to the input is performed (S60). There may be various processes, such as: changing the page of the item trade screen to another page when accepting an L-button or R-button input; sorting the items when accepting an X-button input; and displaying detailed information on an item designated by the cursor when accepting a Y-button input.

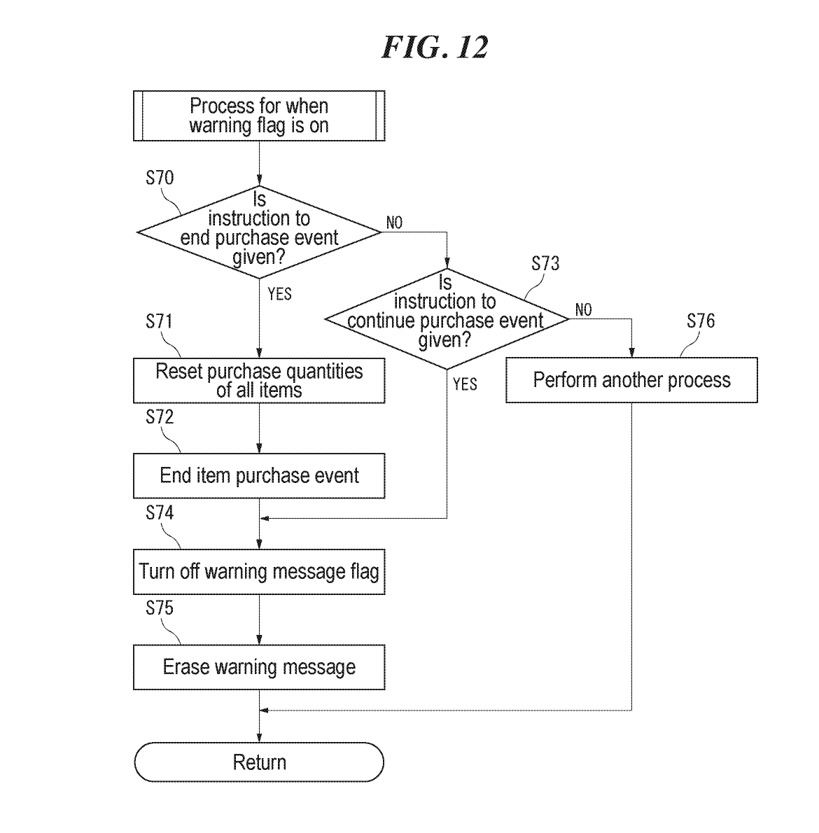

FIG. 12 shows a process for when the warning message flag is on. Since the apparatus 10 turns on the warning flag (S47) and then generates the warning message (S48) as described with FIG. 9, the warning message is displayed when the warning flag is on, and as shown in FIG. 5 for example, the warning message M asking if the item purchase event is to be ended or not is shown to the user.

The game apparatus 10 determines whether an instruction to end the purchase event is given or not (S70). The instruction to end the purchase event is pressing a button other than the B button, or pressing the confirm button (e.g., the X button) with the "Leave Store" button being designated by the cursor. If the instruction to end the purchase event is given (YES at S70), the purchase quantities of all the items on the item purchase screen are reset (S71), the user's character is caused to leave the store, and the item purchase event is ended (S72). The game apparatus 10 then turns off the warning message flag (S74), and erases the warning message (S75).

If the determination at the step S70 indicates that no instruction to end the item purchase event is given (NO at S70), the game apparatus 10 determines whether an instruction to continue the purchase event is given or not (S73). The instruction to continue the item purchase event is pressing the B button, or pressing the confirm button (e.g., the X button) with the "Back" button being designated by the cursor. If the instruction to continue the purchase event is given (YES at S73), the game apparatus 10 then turns off the warning message flag (S74), and erases the warning message (S75). With the pop-up warning message being erased, the item purchase screen is displayed and the item purchase event can be continued.

If it is determined at the process of the step S73 that no instruction to continue the purchase event is given (NO at S73), another process according to an operation input is performed (S76). Another process is, for example, a process of moving the cursor in accordance with a direction input.

The above has described the process of the item purchase event performed by the game apparatus 10.

The game apparatus 10 of the embodiment allows the B button to cause different processes of decreasing the item purchase quantity and ending the item purchase event in the item purchase event. Since the B button is intuitively associated with event-ending operations from users' perspective, users can be caused to purchase items also in the item purchase event without their perception being impaired. Particularly, if an item handled in the item purchase event is of a type that is consumed in accordance with the user's use instruction (e.g., items for restoring HP or MP, items for reviving an ally, stamina-restoring items in stamina-system games), a scenario in which the item is purchased frequently in accordance with the progress of the game is envisaged. The process of item purchase event of the embodiment allows for reducing the operational burden on the user and providing the user with significant convenience.

While one or more storage media having stored therein an information processing program, an information processing apparatus, and an information processing method of the disclosure have been described above with an item purchase event of a game apparatus as an example, the disclosure is not limited to the above-described embodiment.

The above embodiment describes the example in which the item purchase event is ended if the B button is pressed when the acquisition quantity of an item designated by the cursor is zero (the item purchase event is ended if the acquisition quantity of all the items is zero, and the warning message is displayed if the acquisition quantity of any item is not zero). However, in a case in which a minimum is specified for the quantity of item to be purchased in the item trade event, the item purchase event may be ended if an operation input is entered that causes the item acquisition quantity to be decreased to below the minimum quantity. For example, at a store where at least one unit of each item must be purchased and if the B button is pressed when the acquisition quantity of an item designated by the cursor is 1, the item purchase event may be ended instead of the item acquisition quantity being caused to be zero.

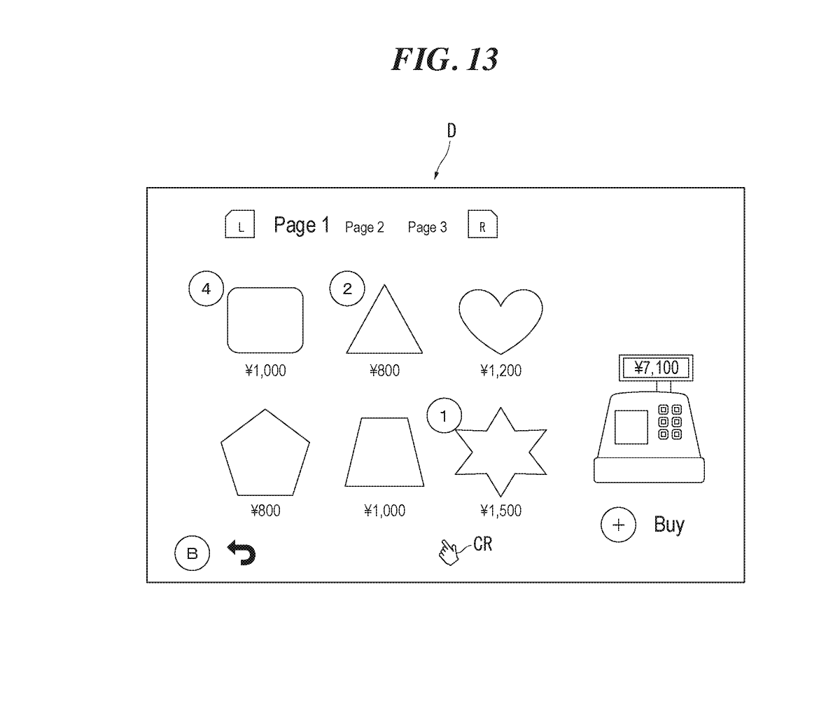

Although the above embodiment describes the example in which the item purchase event is ended when the acquisition quantity of an item designated by the cursor is zero, the item purchase event may be ended if the B button is pressed when no item is designated by the cursor as shown in FIG. 13. To implement such processing, it is sufficient to determine, at the processes of the steps S41 and S44 of the flowchart shown in FIG. 9, that "the purchase quantity of the item indicated by the cursor > 0" is not satisfied when no item is designated by the cursor.

Although the above embodiment describes the example in which the purchase quantities of all the items are reset if the instruction to end the item purchase event is given on the screen where the warning message is displayed (the step S71 in FIG. 12), the process may store the purchase quantities of all the items, read out the stored item purchase quantities at the next visit, and set them as the purchase quantities of their respective items. This allows a user who has left the store once due to certain reasons to continue purchasing items from the previous state.

Alternatively, the process may store the purchase quantities of each item when items are purchased and the item purchase event is ended (the step S51 in FIG. 10), read out the stored item purchase quantities at the next visit, and cause those to be current item purchase quantities. This saves the trouble of specifying the purchase quantities of each item and improves convenience when the same items are repeatedly purchased in the same quantities.

While in the embodiment described above items of a plurality of types can be purchased together on the item purchase screen as shown in FIGS. 3 and 4, the game may provide an item purchase screen on which items of one type are purchased at a time instead of items of a plurality of types being purchased together. Items that cannot be purchased with other types of items include, for example, interior decor for homes (e.g., wall patterns and floor patterns).

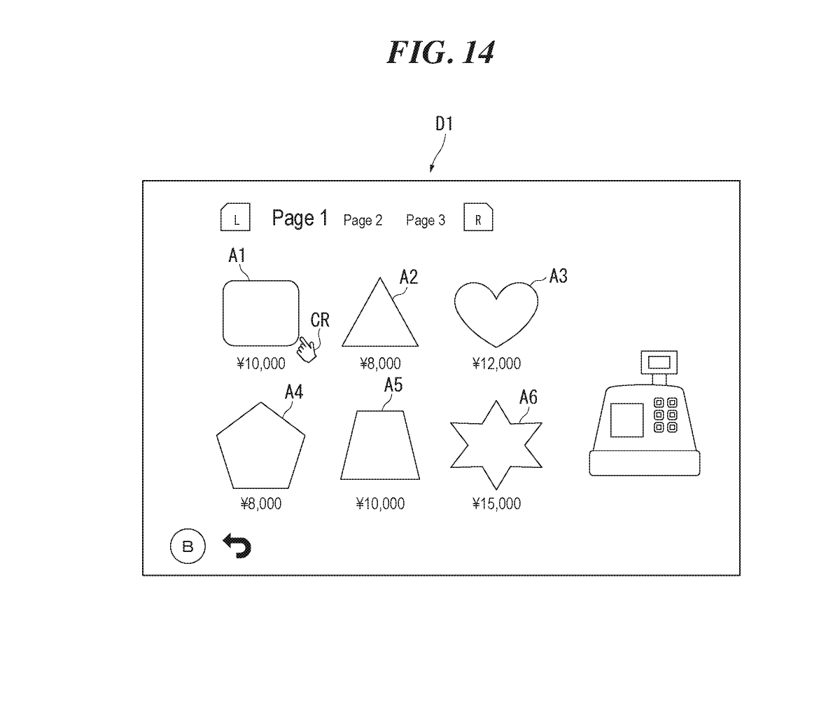

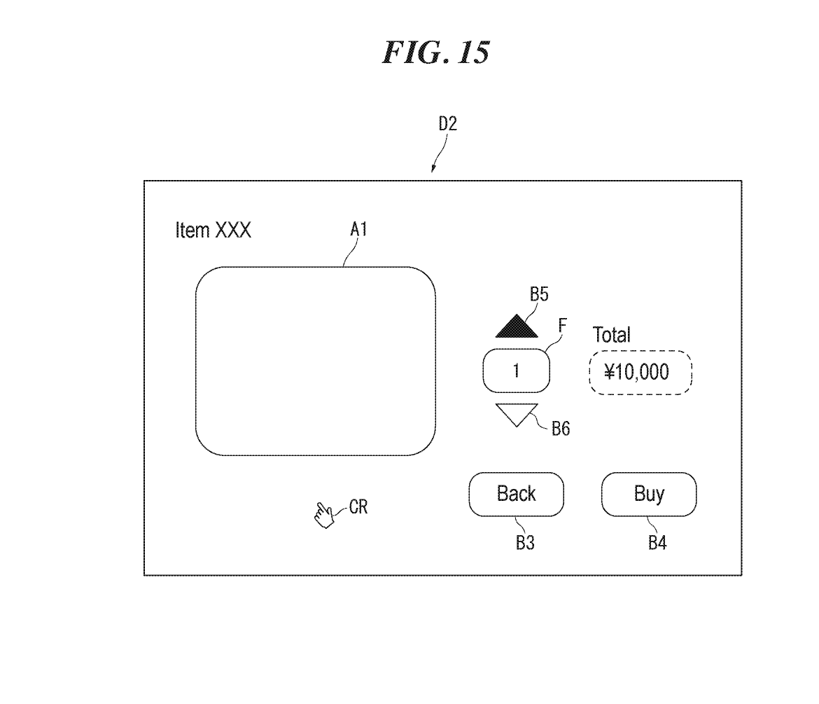

FIG. 14 shows an example of an item purchase screen D1 on which items of different types cannot be purchased together. The A button cannot cause the item purchase quantity to be increased on this item purchase screen D1. The B button also cannot cause the item purchase quantity to be decreased, and is assigned solely to leaving the store. Selecting an item designated by the cursor causes the screen to transition to a screen for purchasing the designated item as shown in FIG. 15.

The screen D2 shown in FIG. 15 is for changing the purchase quantity of the designated item and confirming the purchase. The name and image of the item to be purchased are displayed to the left of the center of the screen D2, and the purchase quantity of the item, the corresponding sum total, a "Back" button B3, and a "Buy" button B4 are displayed to the right of the center of the screen D2. An up-pointing triangle button B5 above the purchase quantity is for increasing the purchase quantity, and a down-pointing triangle button B6 below the purchase quantity is for decreasing the purchase quantity. The current purchase quantity is "1" and the item cannot be purchased if the purchase quantity is "0," and therefore the button B6 for decreasing the purchase quantity is deactivated in FIG. 15. If the "Back" button B3 is indicated by the cursor and the confirm button is pressed, the screen returns to the screen shown in FIG. 14 without the item being purchased. If the "Buy" button B4 is indicated by the cursor and the confirm button is pressed, the item of the selected type is purchased in a quantity indicated by the purchase quantity and the screen returns to the screen of FIG. 14.

While the embodiment has been described with a case in which a user purchases items as an example, the disclosure can also be applied to other cases in which the quantity of each of a plurality of items is changed. For example, the disclosure can be applied to a case in which a user sells the user's own items to a shop.

What is claimed is:

1. One or more non-transitory computer-readable storage media having stored therein instructions that, when executed, cause one or more processors to perform operations comprising:
performing an item trade event in accordance with an event start instruction based on an operation input,
wherein the item trade event comprises:
displaying an item trade screen that includes a cursor and a plurality of items;
moving the cursor in accordance with a first operation input;
increasing an item acquisition quantity of one of the items designated by the cursor in accordance with a second operation input, the item acquisition quantity indicating a quantity of item to be acquired by a user;
decreasing the item acquisition quantity of one of the items designated by the cursor in a case where the item acquisition quantity can be decreased, and ending the item trade event without causing the user to acquire any of the items in a case where the item acquisition quantity cannot be decreased, in accordance with a third operation input; and
causing the user to acquire the items each having a quantity determined according to the corresponding item acquisition quantity in accordance with an acquisition instruction based on an operation input.

2. The one or more non-transitory computer-readable storage media according to claim 1, wherein the item trade event further comprises:
displaying a warning message for warning of an end of the item trade event without ending the item trade event in a case where the item acquisition quantity of one of the items designated by the cursor cannot be decreased in accordance with the third operation input; and
ending the item trade event without causing the user to acquire any of the items in a case where an end instruction based on an operation input different from the third operation input is issued while the warning message is displayed.

3. The one or more non-transitory computer-readable storage media according to claim 2, wherein the item trade event further comprises:
hiding the warning message without ending the item trade event in a case where the third operation input is entered while the warning message is displayed.

4. The one or more non-transitory computer-readable storage media according to claim 2, wherein the item trade event further comprises:
displaying the warning message without ending the item trade event in a case where the item acquisition quantity of a first one of the items designated by the cursor cannot be decreased and that the item acquisition quantity of a second one of the items can be decreased in accordance with the third operation input; and
ending the item trade event without displaying the warning message and without causing the user to acquire any of the items in a case where any of the item acquisition quantities of the items cannot be decreased in accordance with the third operation input.

5. The one or more non-transitory computer-readable storage media according to claim 1, wherein the item trade event further comprises:
determining whether a continuous input condition is satisfied or not, the continuous input condition being satisfied when a continuous operation input is generated over a first period; and
decreasing the item acquisition quantity of one of the items designated by the cursor in a case where the item acquisition quantity can be decreased, and keeping the item trade event running in a case where the item acquisition quantity cannot be decreased, while the third operation input satisfies the continuous input condition.

6. The one or more non-transitory computer-readable storage media according to claim 1, wherein the item trade event further comprises:
decreasing a quantity of a designated item owned by the user and causing the item to be used, in accordance with an item use instruction based on an operation input.

7. The one or more non-transitory computer-readable storage media according to claim 1, wherein the item trade event further comprises:
switching between a first item trade screen including at least a first item and a second item trade screen including at least a second item in accordance with a screen switch instruction based on an operation input; and
causing the user to acquire the first and second items each having a quantity determined according to the corresponding item acquisition quantity in accordance with the acquisition instruction.

8. The one or more non-transitory computer-readable storage media according to claim 7, wherein the item trade event further comprises:
displaying a warning message without ending the item trade event in a case where the item acquisition quantity of a first one of the items designated by the cursor cannot be decreased and that the item acquisition quantity of a second one of the items included in the first or second item trade screen can be decreased in accordance with the third operation input; and
ending the item trade event without displaying the warning message and without causing the user to acquire any of the items in a case where any of the item acquisition quantities of the items included in the first or second item trade screen cannot be decreased in accordance with the third operation input.

9. The one or more non-transitory computer-readable storage media according to claim 1, wherein the item trade event further comprises:
ending the item trade event without causing the user to acquire any of the items in a case where the third operation input is entered without any of the items being designated by the cursor.

10. An information processing apparatus comprising one or more processors, memory, an input unit, and an output unit, the one or more processors being caused to perform operations comprising:
performing an item trade event in accordance with an event start instruction based on an operation input,
wherein the item trade event comprises:
displaying an item trade screen that includes a cursor and a plurality of items;
moving the cursor in accordance with a first operation input;
increasing an item acquisition quantity of one of the items designated by the cursor in accordance with a second operation input, the item acquisition quantity indicating a quantity of item to be acquired by a user;
decreasing the item acquisition quantity of one of the items designated by the cursor in a case where the item acquisition quantity can be decreased, and ending the item trade event without causing the user to acquire any of the items in a case where the item acquisition quantity cannot be decreased, in accordance with a third operation input; and
causing the user to acquire the items each having a quantity determined according to the corresponding item acquisition quantity in accordance with an acquisition instruction based on an operation input.

11. An information processing method performed by a computer, comprising:
performing an item trade event in accordance with an event start instruction based on an operation input,
wherein the item trade event comprises:
displaying an item trade screen that includes a cursor and a plurality of items;
moving the cursor in accordance with a first operation input;
increasing an item acquisition quantity of one of the items designated by the cursor in accordance with a second operation input, the item acquisition quantity indicating a quantity of item to be acquired by a user;
decreasing the item acquisition quantity of one of the items designated by the cursor in a case where the item acquisition quantity can be decreased, and ending the item trade event without causing the user to acquire any of the items in a case where the item acquisition quantity cannot be decreased, in accordance with a third operation input; and
causing the user to acquire the items each having a quantity determined according to the corresponding item acquisition quantity in accordance with an acquisition instruction based on an operation input.

12. An information processing system comprising one or more processors, memory, an input unit, and an output unit, the one or more processors being caused to perform operations comprising:
performing an item trade event in accordance with an event start instruction based on an operation input,
wherein the item trade event comprises:
displaying an item trade screen that includes a cursor and a plurality of items;
moving the cursor in accordance with a first operation input;
increasing an item acquisition quantity of one of the items designated by the cursor in accordance with a second operation input, the item acquisition quantity indicating a quantity of item to be acquired by a user;
decreasing the item acquisition quantity of one of the items designated by the cursor in a case where the item acquisition quantity can be decreased, and ending the item trade event without causing the user to acquire any of the items in a case where the item acquisition quantity cannot be decreased, in accordance with a third operation input; and
causing the user to acquire the items each having a quantity determined according to the corresponding item acquisition quantity in accordance with an acquisition instruction based on an operation input.
